(19) United States
(12) Patent Application Publication
(10) Pub. No.: US 2009/0295833 A1
(43) Pub. Date: Dec. 3, 2009

(54) METHOD AND APPARATUS FOR CONTROLLING DISPLAY DEVICE

(75) Inventor: Jin KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/331,876

(22) Filed: Dec. 10, 2008

(30) Foreign Application Priority Data
May 28, 2008 (KR) 10-2008-0049684

(51) Int. Cl. G09G 5/12

(52) U.S. Cl. 345/660

(57) ABSTRACT

Provided are method and apparatus for controlling a display device by generating a virtual display device. The method includes generating at least one virtual display device by changing a setting of a display driver of the display device, and dividing a screen of the display device according to the at least one virtual display device. By using the method, the display device can be controlled by generating the virtual display device via the display drive of the display device. Accordingly, a user can increase application plans of a wide screen monitor, the display device can be effectively controlled or used since various types of division is possible in a driver level, and various types of display devices can be supported.

### CROSS-REFERENCE TO RELATED PATENT APPLICATION

This application claims priority from Korean Patent Application No. 10-2008-0049684, filed on May 28, 2008 in the Korean Intellectual Property Office, the disclosure of which is incorporated herein in its entirety by reference.

### BACKGROUND OF THE INVENTION

1. Field of the Invention

Methods and apparatuses consistent with the present invention relate to controlling a display device, and more particularly, to controlling a display device by generating a virtual display device.

2. Description of the Related Art

Wide screen monitors have a relatively long length, and thus are useful when a screen needs to be wide or while watching a high quality movie. However, in an overall point of view, empty spaces are formed on sides of wide screen monitors when a general program is used. In order to remove such empty spaces, a screen is newly formed by displaying several windows, and using a function of full view or checkerboard view provided by an operating system or an application. When a screen is controlled by using such a screen forming method, user confusion may occur since an application range differs in each application.

Also, a window arrangement supported in a display device by a related art operating system is very limited, i.e., only a tetragonal window arrangement is supported, and thus various types of display devices cannot be supported. FIG. 1 is a diagram illustrating a circular display device 101. Referring to FIG. 1, a window arrangement provided in the circular display device 101 is a tetragonal window 102 that circumscribes the circular display device 101. When the tetragonal window 102 is displayed on the circular display device 101, capacity of a memory frame buffer may be wasted or an accurately desired screen may not be provided.

### SUMMARY OF THE INVENTION

The present invention provides a method and apparatus for controlling a display device by generating a virtual display device by changing a setting of a display driver of the display device.

The present invention also provides a method and apparatus for controlling a display device by recognizing a shape of a screen of the display device and generating a virtual display device according to the recognized shape, in order to support various types of display devices.

According to an aspect of the present invention, there is provided a method of controlling a display device, the method including: generating at least one virtual display device by changing a setting of a display driver of the display device; and dividing a screen of the display device according to the at least one virtual display device.

The method may further include scanning an image on the at least one virtual display device.

The method may further include changing each location of the divided screens.

According to another aspect of the present invention, there is provided a method of controlling a display device, the method including: recognizing a shape of a screen of the display device; and generating at least one virtual display device according to the recognized shape.

The generating of the at least one virtual display device may include generating at least one virtual display device in an area excluding a screen displaying an actual display device on the recognized shape.

The generating of the at least one virtual display device may include: generating a largest tetragonal virtual display device contained in the recognized shape; and generating at least one virtual display device in an area excluding a screen displaying the largest tetragonal virtual display device.

The method may further include scanning an image on the at least one virtual display device.

The generating of the at least one virtual display device may include generating the at least one virtual display device by changing a setting of a display driver of the display device.

According to another aspect of the present invention, there is provided a computer-readable medium to contain computer-readable codes as a program to execute method of controlling a display device, the method including: generating at least one virtual display device by changing a setting of a display driver of the display device; and dividing a screen of the display device according to the at least one virtual display device.

According to another aspect of the present invention, there is provided a display device including: a display driver setting unit, which sets a display driver of the display device; and a virtual display device generating unit, which generates at least one virtual display device by changing the setting of the display driver.

According to another aspect of the present invention, there is provided a display device including: a controlling unit, which recognizes a shape of a screen of the display device; and a virtual display device generating unit, which generates at least one virtual display device according to the recognized shape.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a circular display device;

FIG. 2 is a block diagram illustrating a display device generating a virtual display device, according to an exemplary embodiment of the present invention;

FIG. 3 is a diagram illustrating a screen of an application controlling a display device, according to an exemplary embodiment of the present invention;

FIG. 4 is a diagram illustrating divided screens of a display unit, according to an exemplary embodiment of the present invention;

FIG. 5 is a diagram illustrating virtual display devices, according to an exemplary embodiment of the present invention;

FIG. 6 is a flowchart illustrating a method of controlling a display device that generates a virtual display device, according to an exemplary embodiment of the present invention; and

FIG. 7 is a flowchart illustrating a method of controlling a display device that generates a virtual display device, according to another exemplary embodiment of the present invention.

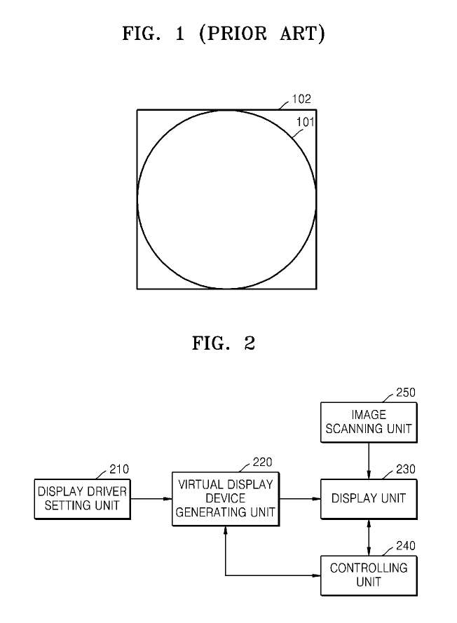

### DETAILED DESCRIPTION OF EXEMPLARY EMBODIMENTS OF THE INVENTION

Hereinafter, exemplary embodiments of the present invention will be described with reference to the accompanying drawings.

FIG. 2 is a block diagram illustrating a display device generating a virtual display device, according to an exemplary embodiment of the present invention.

Referring to FIG. 2, the display device includes a display driver setting unit 210, virtual display device generating unit 220, a display unit 230, a controlling unit 240, and an image scanning unit 250.

The display driver setting unit 210 sets a display driver of the display device. The display driver enables the display device to operate in an operating system. The display device requires the display driver so as to be connected to other devices. Here, the operating system is a program that enables a user to use the display device by controlling hardware and software of the display device. Such a program manages various display resources by acting as an interface between the hardware and an application program. In other words, the program provides an interaction between the user and the display device while controlling operations of the display device, and controls the display device by determining an order of performing several operations. The operating system may not only control the display device, but may also control the entire system including the display device.

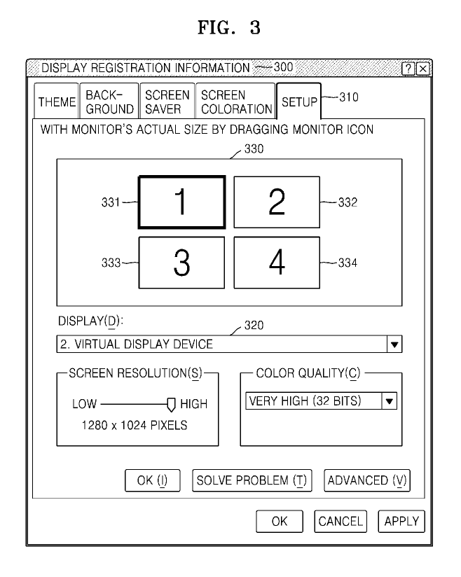

FIG. 3 is a diagram illustrating a screen of an application 300 for controlling a display device, according to an exemplary embodiment of the present invention.

FIG. 3 illustrates the application 300 in Microsoft Windows XP, and is an exemplary diagram for describing the current exemplary embodiment, and thus the application 300 is not limited thereto.

Referring to FIG. 3, the application 300 includes a background of the display device, a screen saver, screen coloration, and a setup menu 310. A display driver 320 of the display device, screen resolution, and color quality can be changed in the setup menu 310. Also, an established display device 330 is illustrated, and each of display devices 331, 332, 333, and 334 are illustrated. The display driver 320 is set as a virtual display device, and this will be described later.

Referring to FIGS. 2 and 3, the virtual display device generating unit 220 generates at least one virtual display device by changing setting of the display driver 320. For example, when the display driver 320 is set as a virtual display device, at least one virtual display device is generated. In FIG. 3, three virtual display devices 332, 333, and 334 are generated. The first display device 331 is a primary display device, i.e., an actual display device. According to another exemplary embodiment, the first display device 331 may also be a virtual display device. The number of generated virtual display devices is not limited. A virtual display device may be automatically generated according to the shape of the display unit 230 of the display device, or generated by a user.

The controlling unit 240 divides the screen of the display unit 230 according to the generated virtual display devices. The controlling unit 240 uniformly divides the screen of the display unit 230 according to the primary display device and the generated virtual display devices. The generated virtual display devices may be placed on any spaces of the screen of the display unit 230. The user may change the locations of the divided screen.

The image scanning unit 250 scans an image on the generated virtual display devices. Accordingly, the user can use the display device like using a multi-display device by using the virtual display devices. For example, in the case of a window operating system, one frame buffer controls one screen of the display unit 230, and thus any other additional operations are not required, besides generating the virtual display devices.

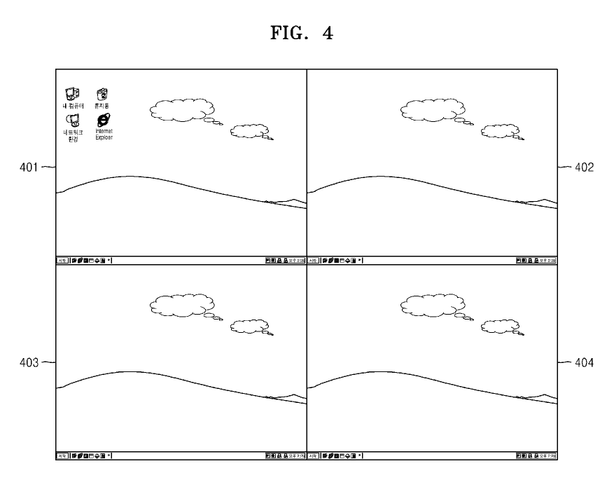

FIG. 4 is a diagram illustrating divided screens of a display unit, according to an exemplary embodiment of the present invention. Referring to FIG. 4, an image is scanned on each of display devices 401, 402, 403, and 404. The display device 401 on the top left is a primary display device. However, the location of primary display device is not limited thereto, and another display device may be a primary display device according to a user or a predetermined algorithm.

A display device generating a virtual display device, according to another exemplary embodiment will now be described.

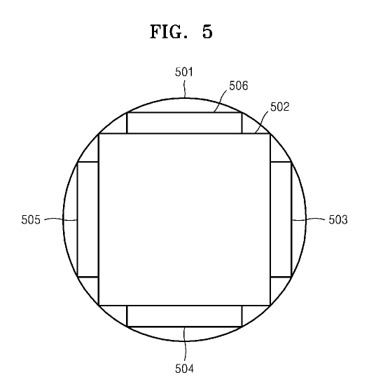

FIG. 5 is a diagram illustrating virtual display devices according to an exemplary embodiment of the present invention.

Referring to FIG. 5, a circle 501 is the display unit 230 of the display device, i.e., the shape of the display unit 230 is circular. Generally, the shape of the display unit 230 is tetragonal, but the shape may vary. The controlling unit 240 recognizes the shape of the display unit 230.

The virtual display device generating unit 220 generates at least one virtual display device according to the recognized shape of the display unit 230. The virtual display device unit 220 can generate virtual display devices 503, 504, 505, and 506 in an area excluding an actual display device, i.e. a primary display device 502, within the recognized shape. Alternatively, the virtual display device generating unit 220 may generate a largest tetragonal virtual display device 502 from among tetragons contained in the display unit 230, and generate virtual display devices 503, 504, 505, and 506 in an area excluding the largest tetragonal virtual display device 502, according to the recognized shape. Here, a shape of generated virtual display device is not limited to a tetragon, and may vary. Also, the number of generated virtual display devices is not limited. Generally, as the number of virtual display devices increase, they become similar to the shape of the display unit 230. The virtual display device generating unit 220 may generate a virtual display device as the display driver setting unit 210 changes setting of a display driver.

The image scanning unit 250 scans an image on virtual display devices. The image scanning unit 250 may scan an image corresponding to one screen on an actual display device and virtual display devices. Alternatively, the image scanning unit 250 may scan an image corresponding to an independent image on each display device.

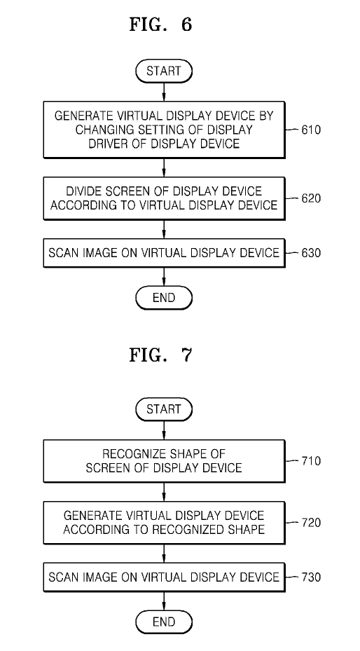

FIG. 6 is a flowchart illustrating a method of controlling a display device that generates a virtual display device, according to an exemplary embodiment of the present invention.

In operation 610, a virtual display device is generated by changing a setting of a display driver of the display device. The display driver enables the display device to operate in an operating system, and the display device requires the display device so as to be connected to other devices. The number of generated virtual display devices is not limited. The virtual display device may be automatically generated according to a shape of screen, or generated according to a user.

In operation 620, the screen of display device is divided according to the virtual display device. The screen is uniformly divided according to an actual display device and the generated virtual display device. The generated virtual display device may be placed in any area of the screen. The user may change the locations of the divided screens.

In operation 630, an image is scanned on the virtual display device. Accordingly, the user can use the display device like using a multi-display device by using the virtual display device.

FIG. 7 is a flowchart illustrating a method of controlling a display device that generates a virtual display device, according to another exemplary embodiment of the present invention.

Referring to FIG. 7, a shape of screen of the display device is recognized in operation 710. The shape is generally a tetragon, but the shape may vary.

In operation 720, a virtual display device is generated according to the recognized shape. One or more virtual display devices are generated according to the recognized shape. The virtual display device may be generated in an area excluding an actual display device, i.e., a primary display device, within the recognized shape. Alternatively, according to the recognized shape, a largest tetragonal virtual display device contained in the shape is generated, and other virtual display devices are generated in an area excluding the largest tetragonal virtual display device. The number of generated virtual display devices is not limited. In overall, as the number of virtual display devices increases, they have the similar shape of the screen. The virtual display device may be generated by changing the setting of a display driver.

In operation 730, an image is scanned on the virtual display device. An image corresponding to one screen may be scanned on the actual display device and the virtual display device. Alternatively, an image corresponding to an independent screen may be scanned on each display device.

According to the exemplary embodiments of the present invention, a display device can be controlled by generating a virtual display device via a display driver of the display device. Accordingly, application plans on a wide screen monitor can be increased, and the display device can be effectively controlled or used by dividing a screen into various shapes in a driver level. Moreover, various types of display device can be supported.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of controlling a display device, the method comprising:
generating at least one virtual display device by changing a setting of a display driver of the display device; and
dividing a screen of the display device into a plurality of divided screens according to the at least one virtual display device.

2. The method of claim 1, further comprising scanning an image on the at least one virtual display device.

3. The method of claim 1, further comprising changing each location of the divided screens.

4. A method of controlling a display device, the method comprising:
recognizing a shape of a screen of the display device; and
generating at least one virtual display device according to the recognized shape.

5. The method of claim 4, wherein the generating the at least one virtual display device comprises generating at least one virtual display device in an area excluding a screen area displaying an actual display device on the recognized shape.

6. The method of claim 4, wherein the generating the at least one virtual display device comprises:
generating a tetragonal virtual display device which has largest size contained in the recognized shape; and
generating at least one virtual display device in an area excluding a screen area displaying the tetragonal virtual display device.

7. The method of claim 4, further comprising scanning an image on the at least one virtual display device.

8. The method of claim 4, wherein the generating the at least one virtual display device comprises generating the at least one virtual display device by changing a setting of a display driver of the display device.

9. A computer-readable medium to contain computer-readable codes as a program to execute method of controlling a display device, the method comprising:
generating at least one virtual display device by changing a setting of a display driver of the display device; and
dividing a screen of the display device into a plurality of divided screens according to the at least one virtual display device.

10. A display device comprising:
a display driver setting unit which sets a display driver of the display device; and
a virtual display device generating unit which generates at least one virtual display device by changing a setting of the display driver.

11. The display device of claim 10, further comprising a controlling unit which divides a screen of the display device into a plurality of divided screens according to the at least one virtual display device.

12. The display device of claim 11, further comprising an image scanning unit which scans an image on the at least one virtual display device.

13. The display device of claim 11, wherein the controlling unit changes each location of the divided screens.

14. A display device comprising:
a controlling unit which recognizes a shape of a screen of the display device; and
a virtual display device generating unit which generates at least one virtual display device according to the recognized shape.

15. The display device of claim 14, wherein the virtual display generating unit generates the at least one virtual display device on an area excluding a screen area displaying an actual display device in the recognized shape.

16. The display device of claim 14, wherein the virtual display generating unit generates a tetragonal virtual display device which has a largest size contained in the recognized shape, and generates at least one virtual display device on an area excluding a screen area displaying the tetragonal virtual display device.

17. The display device of claim 14, further comprising an image scanning unit which scans an image on the at least one virtual display device.

18. The display device of claim 14, further comprising a display driver setting unit which sets a display driver of the display device, wherein the virtual display device generating unit generates the at least one virtual display device by changing a setting of the display driver.
